(19) United States
(12) Patent Application Publication
(10) Pub. No.: US 2024/0092120 A1
(43) Pub. Date: Mar. 21, 2024

(54) Device utilizing the playing of a functioning instrument to cause a paint brush or similar object to paint or draw onto an art medium such as a canvas, creating a visual representation of the music in art form

(71) Applicant: Abraham Zev Wolf Melamed, Scottsdale, AZ (US)

(72) Inventor: Abraham Zev Wolf Melamed, Scottsdale, AZ (US)

(21) Appl. No.: 17/931,547

(22) Filed: Sep. 13, 2022

(51) Int. Cl. B44D 2/00; A46B 17/02; G10C 3/18

(52) U.S. Cl. CPC B44D 2/00; A46B 17/02; G10C 3/18

(57) ABSTRACT

A device that utilizes the playing of a functioning instrument, such as a piano for example purposes, to cause a paint brush or similar object, which is attached to the instrument, to draw or paint onto an art medium such as a canvas. The result is a drawing or painting that includes a visual representation of what was played, as the brush strokes are caused by the playing of the instrument. In one embodiment, a piano is modified by attaching paint brushes or a similar device to the opposite side of the hammers that strike the strings to create sound. The paint brushes are saturated in paint, and a canvas is held in front of the brushes. The keys are played, and the hammers propel forward and then backward. When the hammers of the keys/notes played are propelled backward the touch the canvas, adding paint to the canvas only in the locations where keys/notes are played. The result is a painting depicting the notes on canvas, creating a visual representation of the music on canvas. In another embodiment, other objects, such as pens or pencils, are attached to the piano hammers to create art on paper or canvas using mediums besides for paint. In other embodiments, the playing mechanisms of other musical instruments are utilized to paint onto canvas, or draw onto other mediums, where only the notes or keys being played cause a brush or similar object to strike a canvas or other mediums, thereby creating a visual representation of the music in art form. The device has use in artistic creation, and may have medical use in art therapy.

### CROSS-REFERENCE TO RELATED APPLICATION

The present application is a continuation of the U.S. Provisional Application No. 63/261,108, filed Sep. 13, 2021, which is incorporated by reference in its entirety.

### BACKGROUND OF THE INVENTION

Music and art are two of the most fundamental elements of joy in the lives of humans. Music and art both have utilities as a form of entertainment, as well as a form of therapy. Yet, music and art are rarely crossed over in a way that allows for a two-dimensional experience, wherein one uses their sight as well as their hearing to be immersed in both senses at once in enjoying the experience. If music and art can be combined, it has can have several applications for individuals with, Synesthesia, autism, depression and more. Therefore, a devise that would allow art to be created by music, so that someone could then view the art while immersed in the music and visualize the music on the art medium, would provide great utility.

In modifying a musical instrument so that paint brushes, pens, pencils, markers or other art items can be attached to a part of the instrument enabling it to paint or color as it is played, with the paint or color representing notes that are being played, the final art product can be a visual depiction of the music on canvas or similar medium.

In the example of a piano, when paint brushes are attached to the hammers that strike the strings to make sound, and the brushes are then saturated in paint, when a pianist plays the piano, the hammers strike forward and backward, allowing the brushes to then strike a canvas and leave a brush stroke.

Because the weight of the hammers is key to the ability to strike the strings and make sound, the weight of the paint brush is critical. As such, one embodiment of the paint brushes attached are comprised of a half of a clothes pin, which is then attached to the wooden platform that juts out behind the hammer by tape. The clothes pin then has a toothpick or similar lightweight wood object that attached to it with tape or glue, that allows the toothpick to protrude at an angle away from the piano strings. A small sponge paint brush is then attached to the toothpick with glue.

This is ultimately saturated in paint, allowing it to strike a canvas multiple times without running out of paint. These brushes can then be washed out with water to cleanse for the next use.

In a similar embodiment of the brush function, depicted below, a devise made of lightweight plastic is custom cut for the shape of the hammer, and is then inserted onto the hammer with a paint brush that can be removed and replaced.

When a key/note is played harder than other keys/notes, the paint stroke will be harsher of a brush stroke. Similarly, when the same key/note is played over and over, it will leave a larger grouping of brush strokes in one location of the canvas. As the song is played, the canvas is slowly lowered bit by bit, so that the brush strokes fill the canvas line by line, like the lines of a book. The result is that when a song that is played reaches a crescendo, you can visualize it on the canvas by viewing the large grouping on harsher brush strokes. When a song has a softer trill of notes, you will see softer trills of brush strokes on the canvas. As a result, if one listens to the song while also viewing the final art product, they can watch the song play on the canvas based on the brush strokes.

This creates a new, two-dimensional art and music combined experience, allowing the viewer to enjoy both the music and the art more. Similarly, it can allow people with difficulty hearing to visualize what the music is and will allow those who see sound to combine their Synesthesia experience in a tangible way. It also may help with people with autism and depression to find calm through two separate mediums at once.

An art exhibit may include the piano the art was created on, with the art hanging above it, and speakers playing the song on repeat. One can then experience the entire process at once. It can also allow some to create art that is meaningful to themselves.

In other, similar embodiments on this devise, a violin may be modified so that when each string is played it paints onto a canvas. A drummer may be able to activate a brush with the drumsticks, or even the drums as they are played. Similar uses of other instruments may be used to create similar visual representations of the music on canvas.

### BRIEF DESCRIPTION OF DRAWINGS

These, and further features of the invention, may be better understood with reference to the accompanying specification and drawings depicting the preferred embodiment, in which:

FIG. 1 depicts a portion of the paint brush to be attached to the piano hammers, specifically, the sponge brush glued to the toothpick.

FIG. 2 depicts the paint brushes in final form, with the sponge brushes glued to the toothpick and the toothpicks taped and glued to the half of the clothes pins, ready to be taped to the piano hammers.

FIGS. 3 and 4 Depicts the custom paint brushes taped to the piano hammers.

FIG. 5 Depicts the custom paint brushes taped to the piano hammers from another angle, while some piano keys are played.

FIG. 6 Depicts the custom paint brushes taped to the piano hammers and saturated in paint, ready to be used.

FIG. 7 Depicts an up-close view of the custom paint brushes taped to the piano hammers with residual pain ater the brushes have been used.

FIG. 8 Depicts the custom paint brushes taped to the piano hammers being played and painting onto a canvas.

FIG. 9 Depicts the custom paint brushes taped to the piano hammers and saturated in paint, with residual paint on the performer's hands.

FIG. 10 Depicts a second preferred embodiment of the custom inventions, wherein the paint brushes are propelled forward to strike a canvas placed in front of the brushes.

FIG. 11 Depicts the invention being played for practice, without a canvas.

FIG. 12 Depicts the custom paint brushes taped to the piano hammers and saturated in paint from an overhead view.

FIG. 13 Depicts the inventions and resulting painting, with the name of the performance.

FIG. 14 Depicts the custom paint brushes taped to the piano hammers saturated in paint from an up-close side angle.

FIG. 15 Depicts the custom paint brushes taped to the piano hammers from an above angle with a tape measure measuring the length of the brushes.

FIG. 16 Depicts the invention from the front at a distance.

FIG. 17 Depicts a second preferred embodiment of the custom inventions, wherein the paint brushes are propelled forward to strike a canvas placed in front of the brushes.

FIG. 18 Depicts a third preferred embodiment of the invention wherein actual paintbrushes are taped to the hammers.

FIG. 19 Depicts a drip system installed above the third preferred embodiment wherein paint brushes am attached to the hammers. The drip system allows paint to drip at a consistent rate to saturate the paint brushes

FIG. 20 Depicts an up-close above view of the paint drip system.

FIG. 21 Depicts the paint drip system above the standard paint brushes from a farther out view.

FIG. 22 Depicts another angle of the second preferred embodiment wherein standard paint brushes are attached directly to the piano hammers.

FIG. 23 to 26 Depicts the drip system for the third preferred embodiment in action, replenishing the paint brushes as the piano is played.

FIGS. 27 and 28 Depicts the final product of the paintings created by the second preferred embodiment, wherein the standard non-custom paint brushes are attached directly to the hammers and a drip system replenishes the paint brushes.

FIG. 29 to 32 Depicts the CAD file for a fourth preferred embodiment, a custom-built lightweight plastic cover that would be placed on top of the piano hammers, with a detachable tube for a brush, to allow for more seamless removal and replacement of brush heads.

FIG. 33 Depicts a 3D printed version of the fourth preferred embodiment custom-built lightweight plastic cover that would be placed on top of the piano hammers, with a detachable tube for a brush, to allow for more seamless removal and replacement of brush heads.

FIG. 34 to 36 Depicts two different colored 3D printed versions of the fourth preferred embodiment custom-built lightweight plastic cover placed on top of the piano hammers, with a detachable tube for a brush, to allow for more seamless removal and replacement of brush heads.

FIG. 37 to 42 Depicts paintings that were created by these inventions through the playing of the piano with the modifications.

### DETAILED DESCRIPTION OF THE DRAWINGS

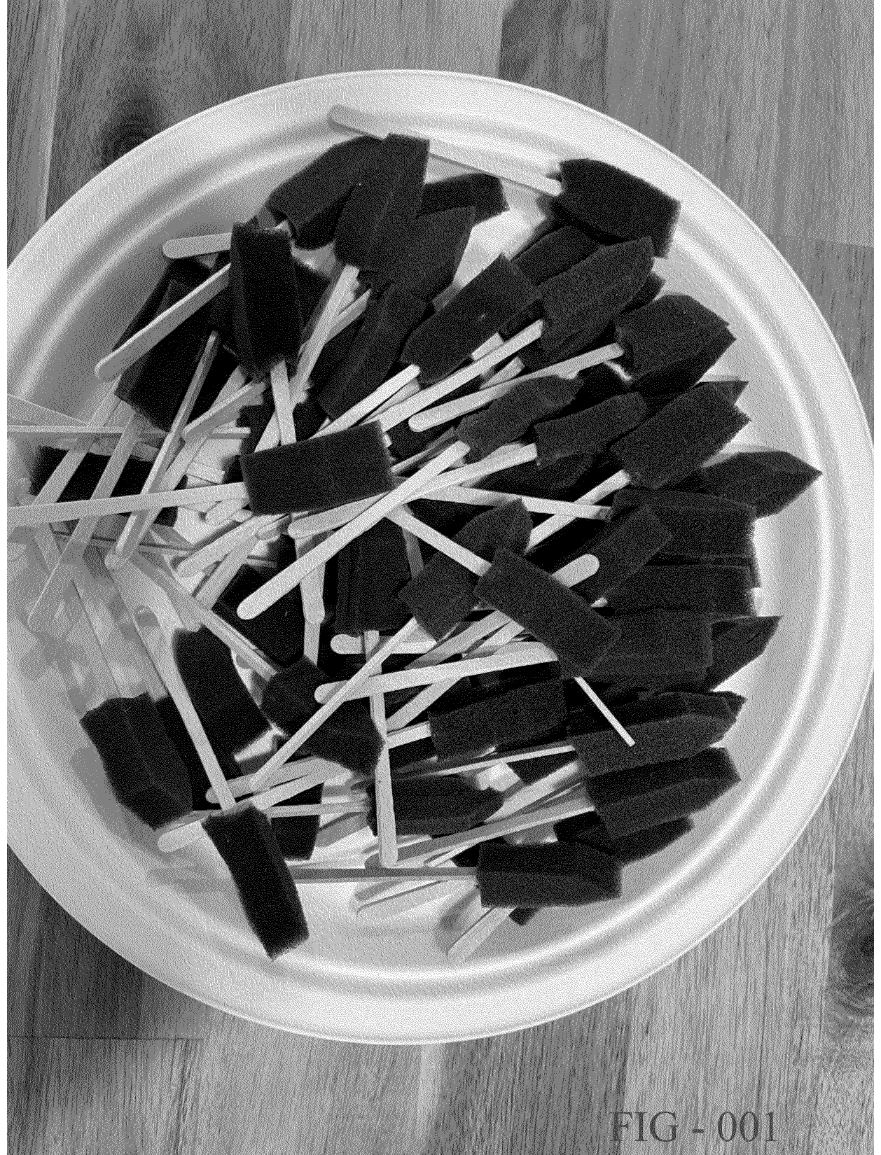

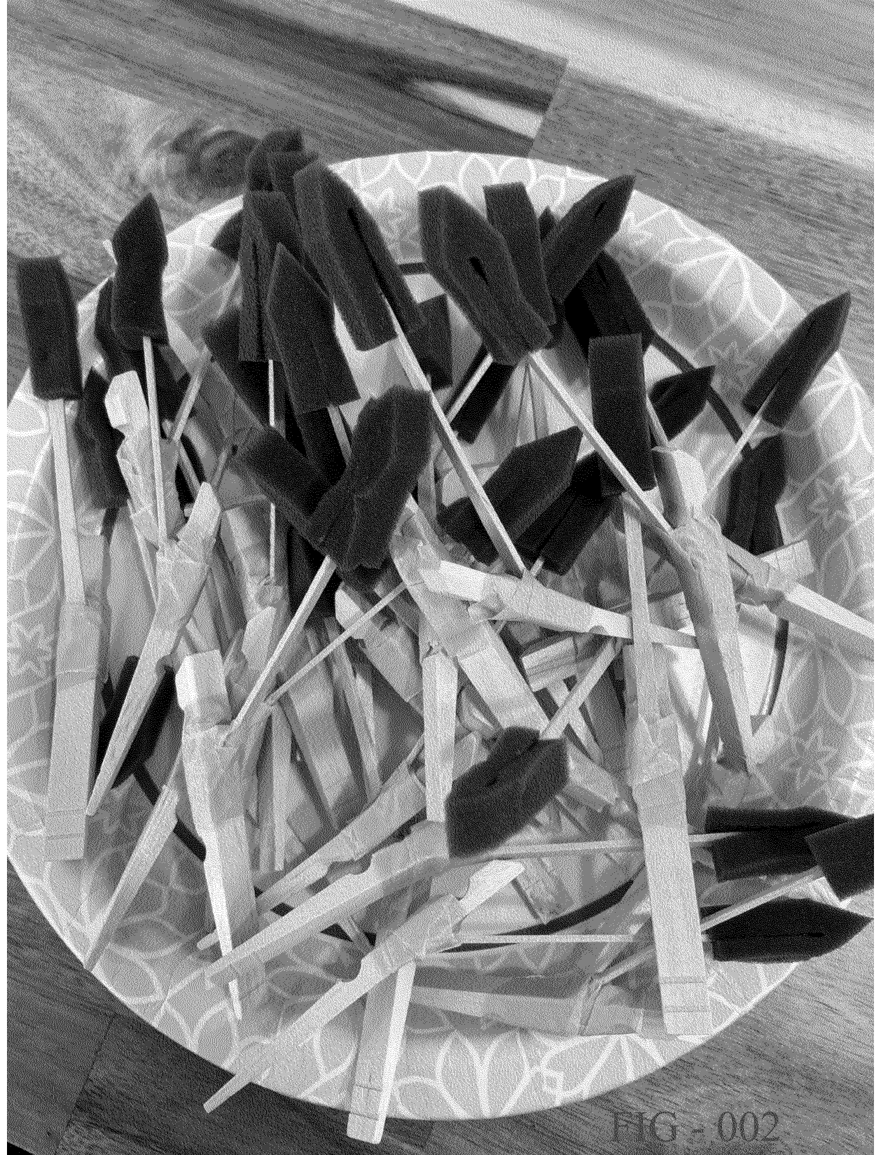

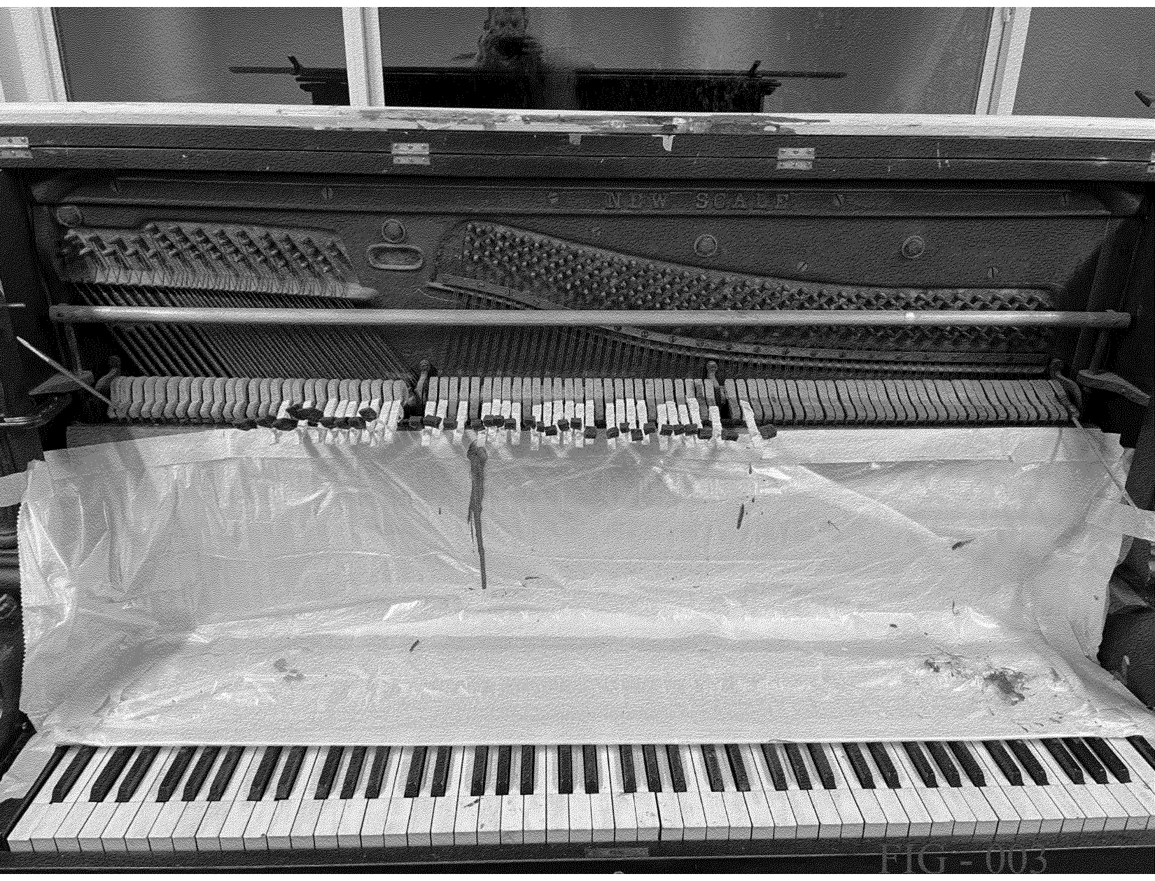

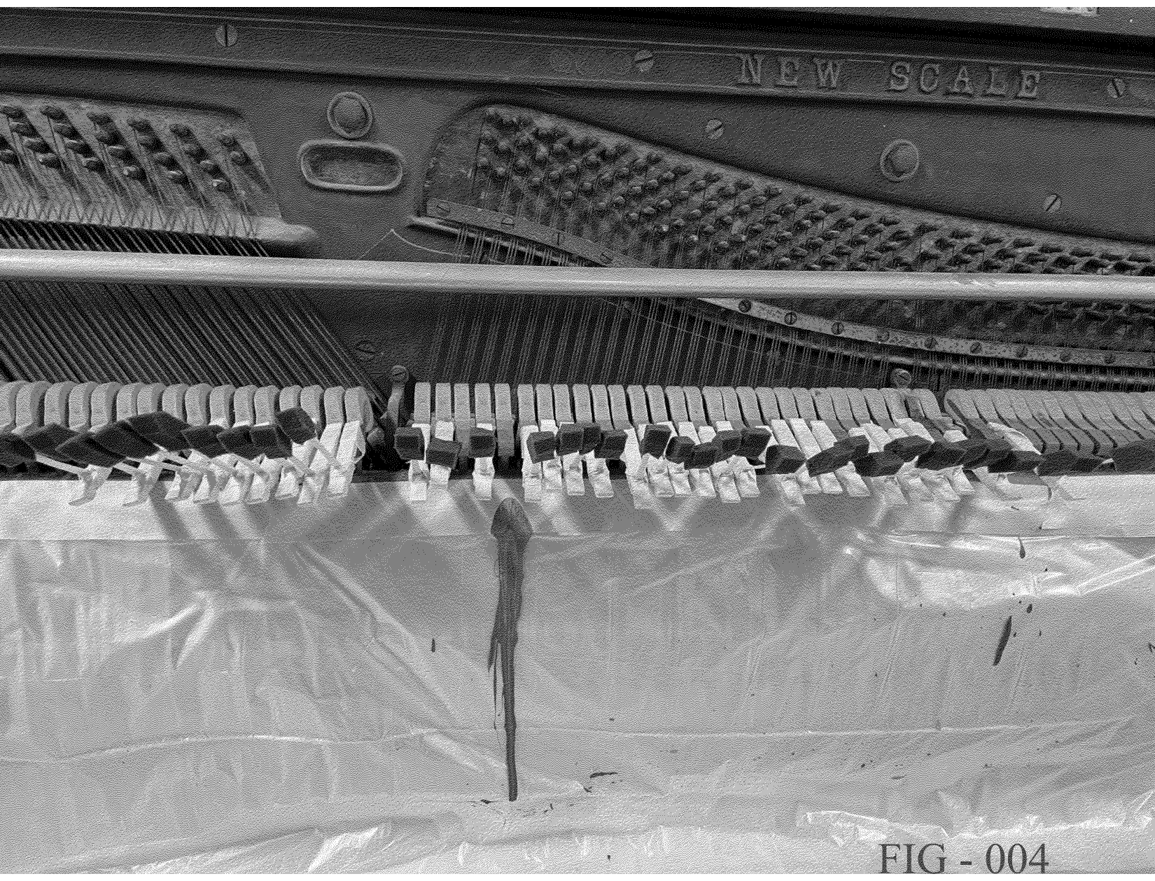

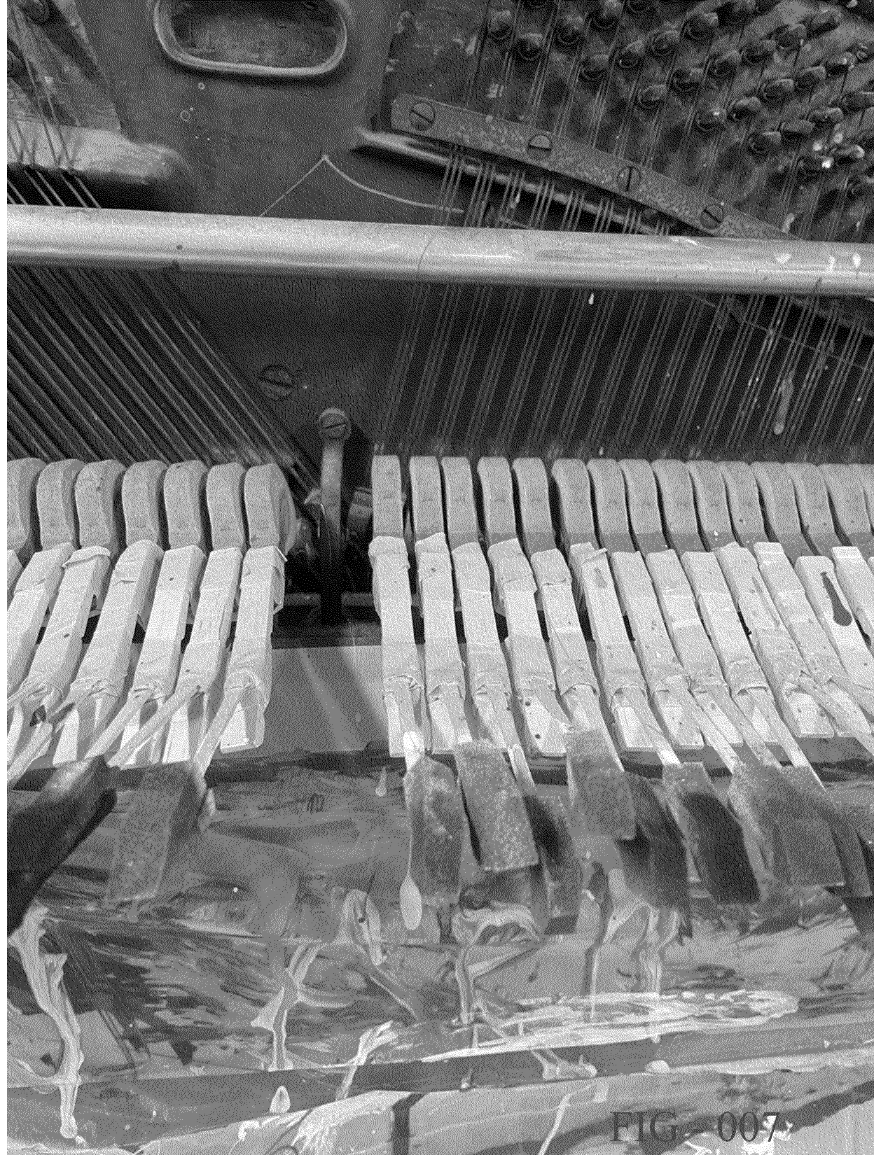

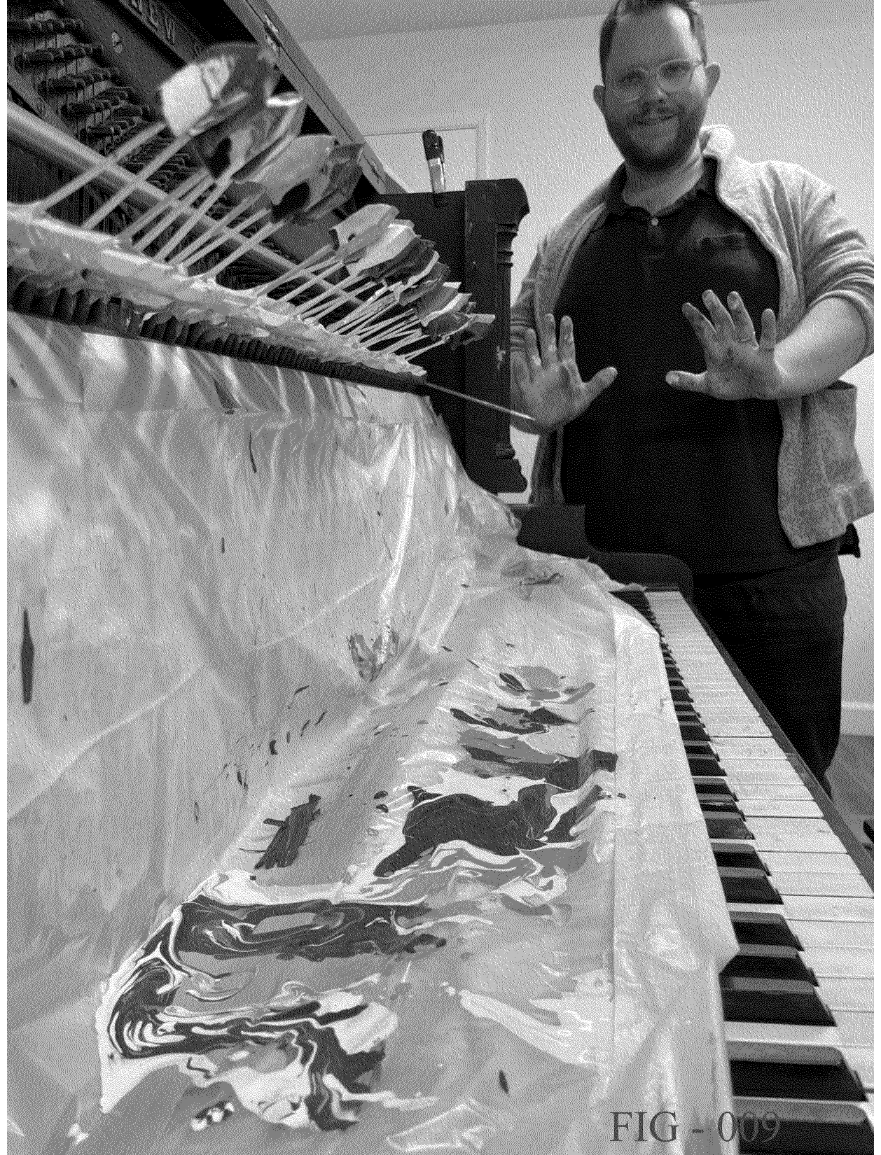

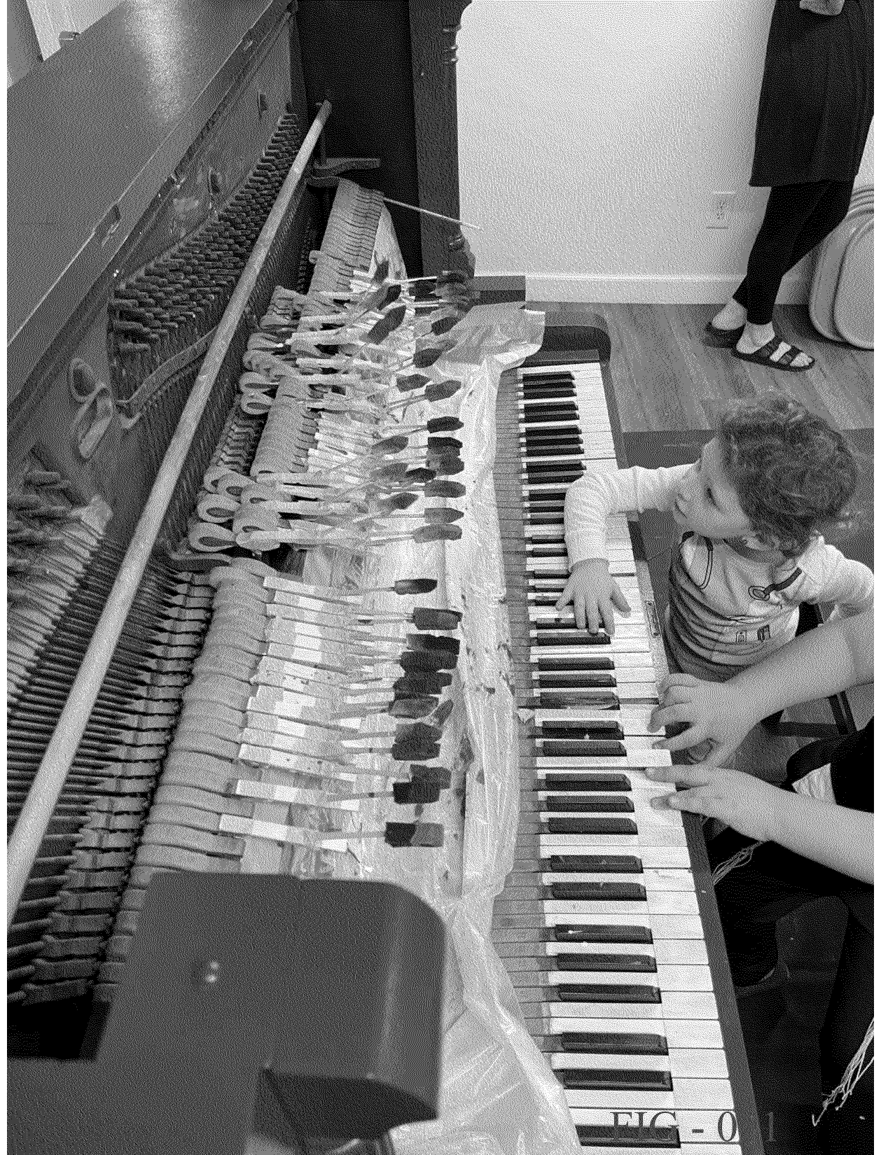

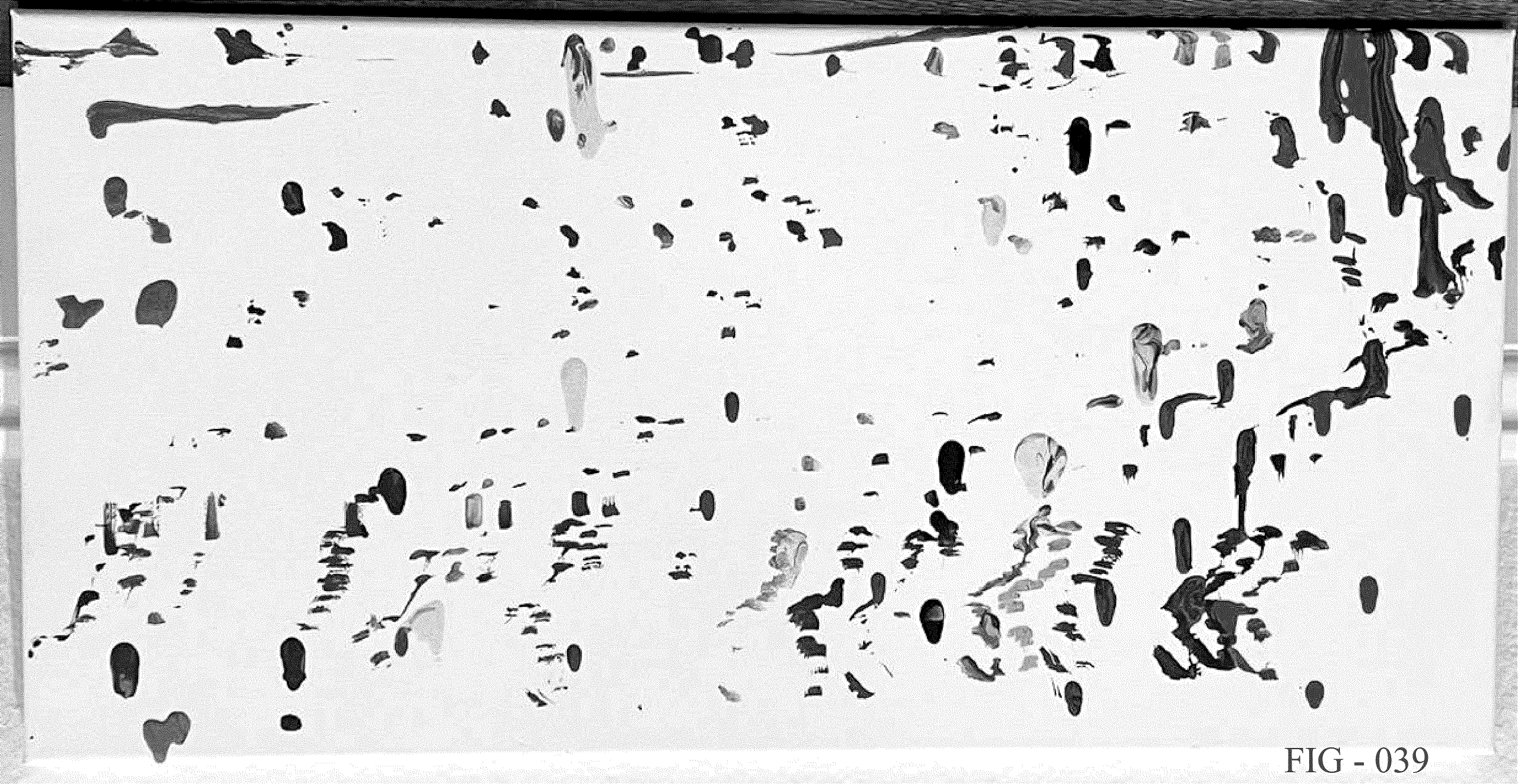

The first preferred embodiment may be understood by referring to FIGS. 1-7 and 9 through 12, which depicts the custom-built paint brushes that are made of a half of a clothes pin, which is then attached to the wooden platform that juts out behind the hammer by tape. The clothes pin then has a toothpick or similar lightweight wood object that attached to it with tape or glue, that allows the toothpick to protrude at an angle away from the piano strings. A small sponge paint brush is then attached to the toothpick with glue. This is ultimately saturated in paint, allowing it to strike a canvas multiple times without running out of paint. These brushes can then be washed out with water to cleanse for the next use. These brushes are then attached to the piano by taping them to the back of the hammers. The brushes are then saturated in paint, as in FIGS. 6, 7 and 9-11. FIG. 8 then depicts the hammer action causing the paint brushes to rise and then fall down, striking the canvas and leaving a brush stroke on the canvas where the hammer for the key/note that has been played is. FIG. 12 gives a view of the paint brushes attached to the hammers from an aerial view, and FIG. 14-15 Depicts the paint brushes from a forward-facing aerial view and from a side view, showing how the brushes attach to the piano hammers. Once the song is completed, the canvas in FIG. 13 and FIG. 37-42, depicts the brush strokes on the canvas after a song has been played, representative of where the notes were played, showing a visual representation of the music on canvas.

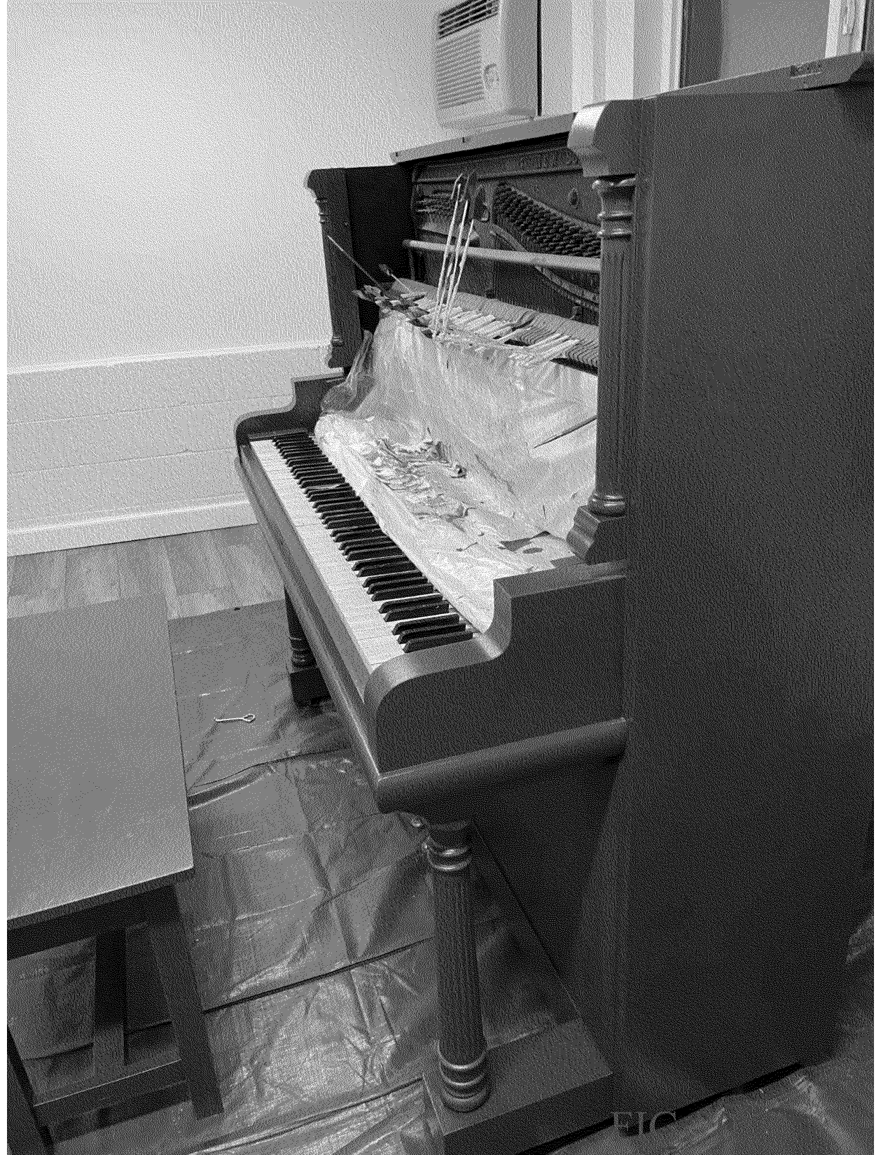

In the second preferred embodiment of the invention, FIGS. 10 and 17 depict a wooden stick attached to a half a clothes pin, with a paint brush angled forward so that the paint brush can strike a canvas held above the piano when the hammer is moving forward as a key/note is played. This allows the brush strokes to be more accurate, as only the brush being played will be struck forward.

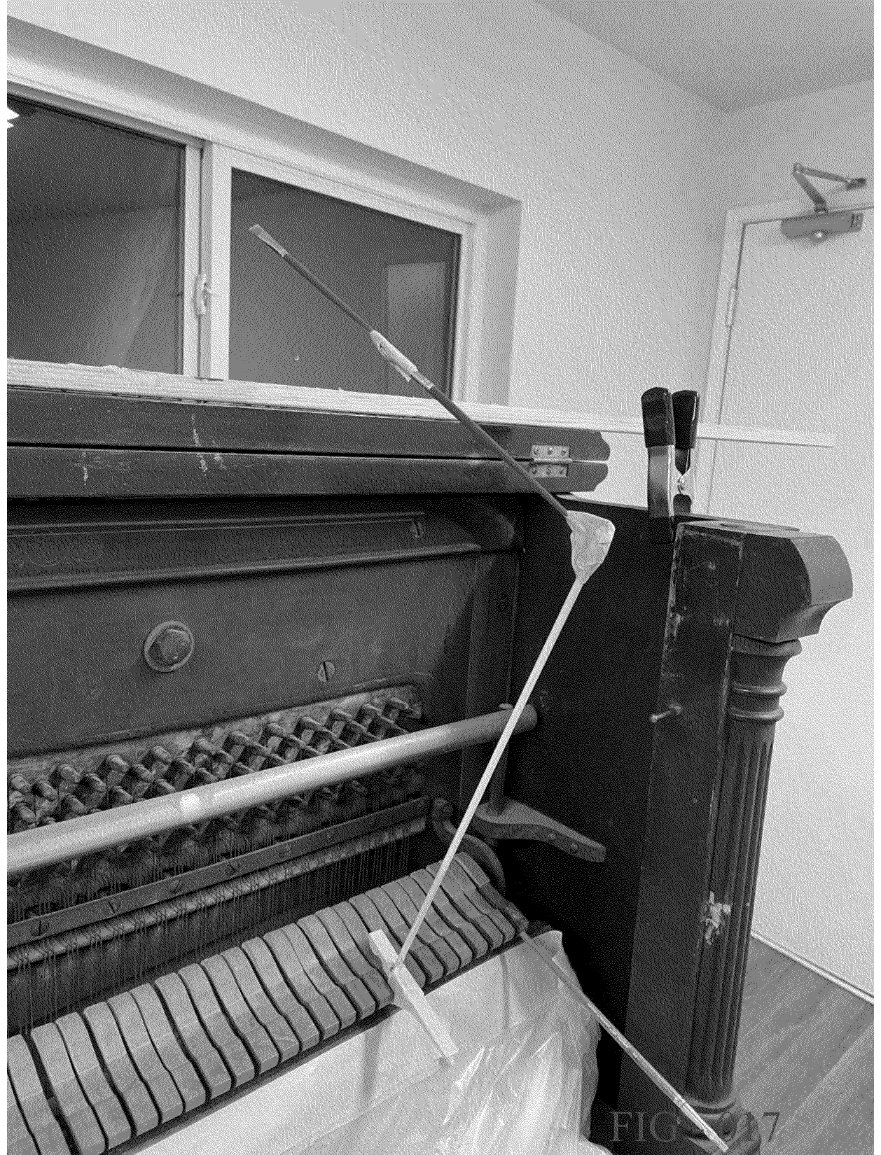

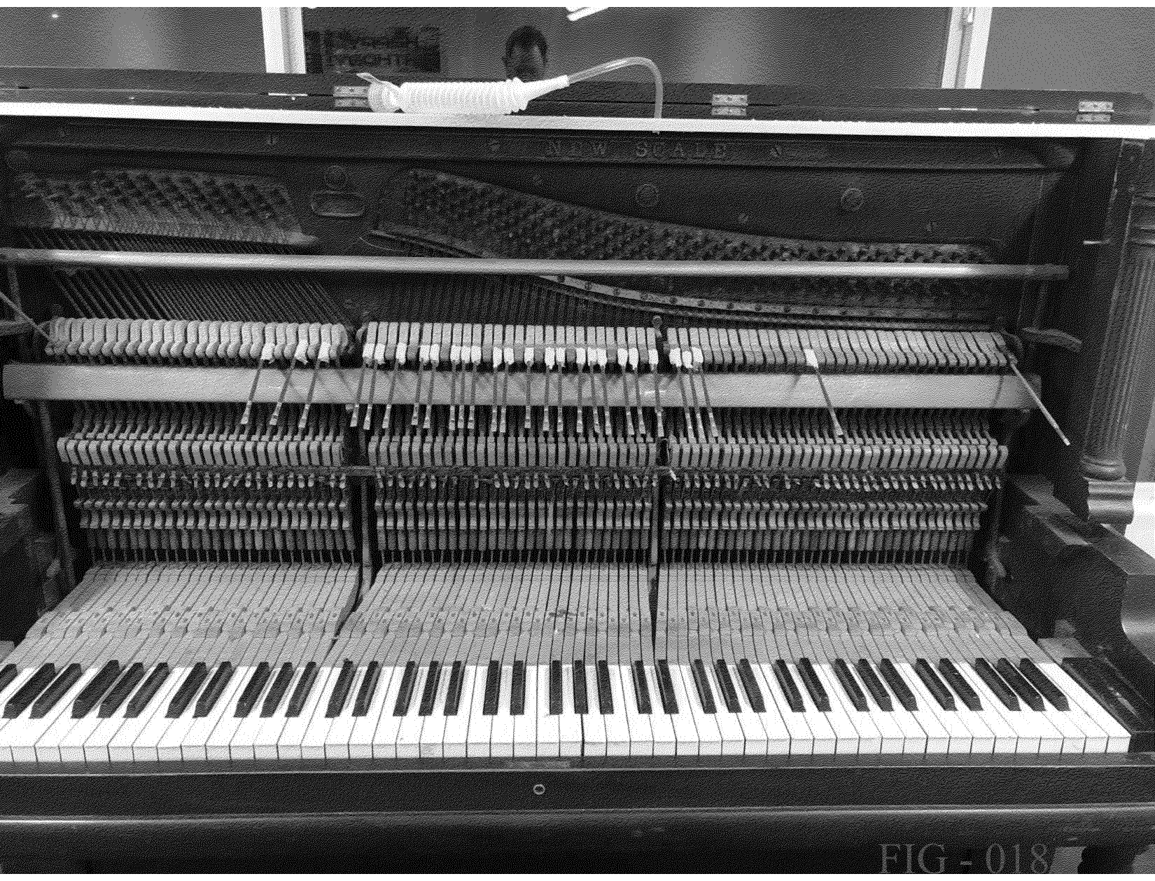

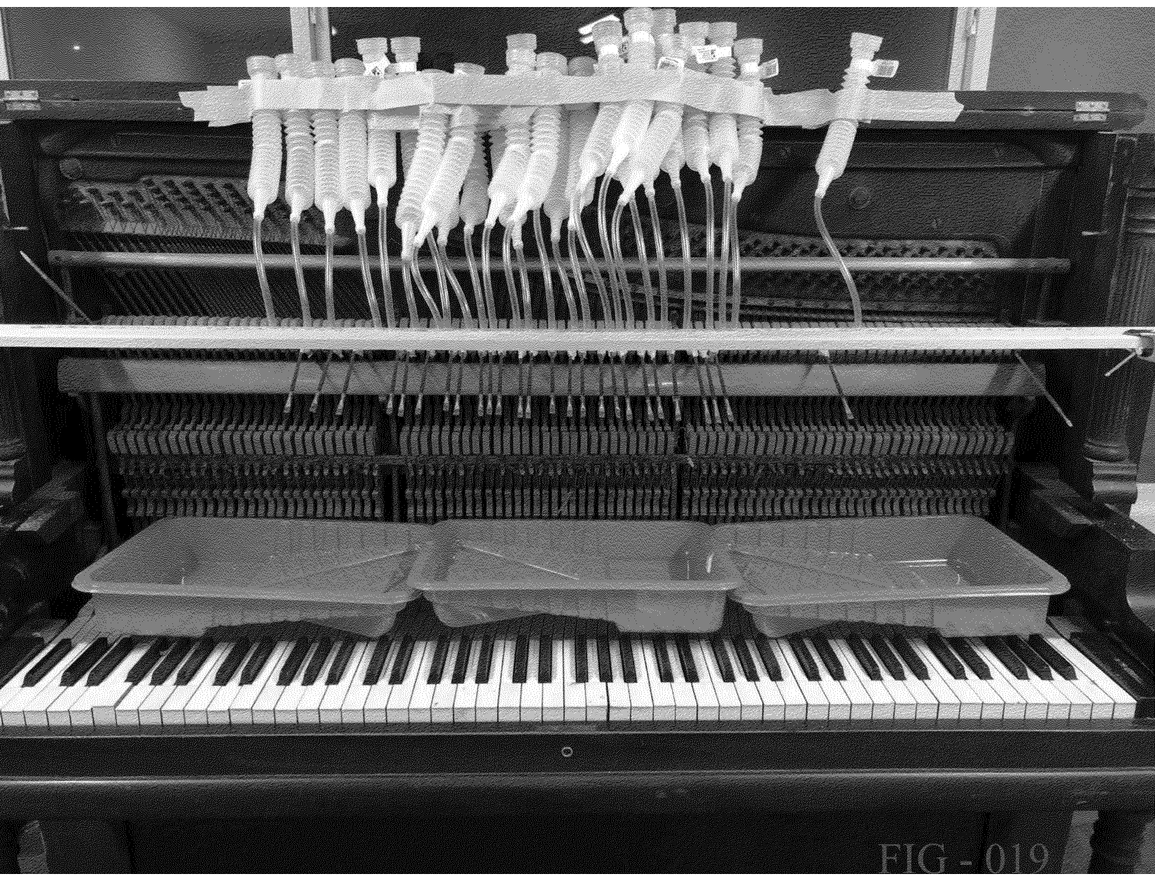

In the third preferred embodiment of the invention, FIG. 18-25 shows standard paint brushes taped to the hammers of a piano so that the brushes will strike a canvas when it returns to the rest position after a key/note is played, but with a paint drip system above the brushes so that the brushes are constantly replenished with paint as the song is played. The drip system is comprised of plastic tubing attached to a larger plastic funnel where paint is poured, and the plastic tubing sits in holes of a board directly above each paint brush so that the pain will flow onto the brush. FIG. 26 shows the paint drip system in action, and FIG. 27-28 depict the brushes after they have been used and the paintings created by the paint brushes with the paint drip system.

In the fourth preferred embodiment of the invention, depicted in FIG. 29-36, a CAD model is created of a lightweight plastic cap to be snapped onto each piano hammer. The square portion that attaches to the hammer also has a round tube that protrudes forward at an angle and all sorts of mediums, sponge brushes, standard brushes, pencils, pens, chalk to name a few can be secured in the plastic tube, allowing easy transition. The CAD model was then 3D printed and tested on the piano, depicted in FIG. 34-36.

### PRIOR ART

The inventor is not aware of any prior inventions that use the action of the instrument to paint onto canvas or otherwise create art. While there have been digital re-creations of music as art through MiDi and other forms, there are not other inventions that actually create art through the pure use of the instrument in its original form.

Relevant prior art might include:

Chinese Pat. No. CN203415221U—Interactive Music Visualization Device

What is claimed is:

1. A device that creates art through being controlled by the playing of any musical instrument: utilizing the playing of a functioning instrument to cause a paint brush or similar object to paint or draw onto an art medium such as a canvas, creating a visual representation of the music in art form.

2. A device that creates art through being controlled by the playing of any musical instrument according to claim 1: in which the musical instrument used is a piano.

3. A device that creates art through being controlled by the playing of any musical instrument according to claim 1: in which the musical instrument used is a guitar.

4. A device that creates art through being controlled by the playing of any musical instrument according to claim 1: in which the musical instrument used is a violin.

5. A device that creates art through being controlled by the playing of any musical instrument according to claim 1: in which the musical instrument used is a flute.

6. A device that creates art through being controlled by the playing of any musical instrument according to claim 1: in which the musical instrument used is a saxophone.

7. A device that creates art through being controlled by the playing of any musical instrument according to claim 1: in which the musical instrument used is a clarinet.

8. A device that creates art through being controlled by the playing of any musical instrument according to claim 1: in which the musical instrument used is a oboe.

9. A device that creates art through being controlled by the playing of any musical instrument according to claim 1: in which the musical instrument used is a ukulele.

10. A device that creates art through being controlled by the playing of any musical instrument according to claim 1: in which the musical instrument used is a drum.

11. A piano that has paint brushes or other art mediums attached to the hammers, allowing it to paint when the piano is played.

12. A custom paint brush that can be attached to a piano hammer.

13. A device according to claim 11 that is a custom paint brush that can be attached to a piano hammer, comprised of a flat piece of material that is secured to the top of the piano hammer with another portion protruding forward to allow an art medium to paint or draw.

14. A device according to claim 11 that is a custom paint brush that can be attached to a piano hammer, comprised of a flat piece of material that is secured to the top of the piano hammer with another portion protruding backward to allow an art medium to paint or draw.

15. A custom apparatus that can be attached to piano hammers to allow a space for an art medium such as a paint brush or a pen to then be attached to the apparatus:

16. devise according to claim 12: Comprised of a hollow square item that wraps around the hammer, and a cylinder tube that juts out, with a hollow tip that allows for a paint brush to be inserted.
